(19) United States
(12) Patent Application Publication
(10) Pub. No.: US 2010/0178029 A1
(43) Pub. Date: Jul. 15, 2010

(54) RECORDING/PLAY BACK APPARATUS, PLAY BACK CONTROL APPARATUS AND METHOD, AND RECORDING/PLAY BACK PROGRAM

(75) Inventor: Yoko MASUO, Iruma-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/614,897

(22) Filed: Nov. 9, 2009

(30) Foreign Application Priority Data
Jan. 15, 2009 (JP) 2009-006803

(51) Int. Cl. H04N 5/91; H04N 5/445

(52) U.S. Cl. 386/71; 348/564; 386/95; 386/125; 348/143; 348/E05.099; 386/E05.003

(57) ABSTRACT

According to one embodiment, it is possible to easily record a master image related to new personal image data on a recording medium, and reproduce the personal image data in synchronization with play back of the master image. In an embodiment of the invention, when a play back module reproduces a master image, an imaging module records a viewer as a personal image. A content management module creates a related information table which relates the personal image to the master image. A synchronous record control module creates synchronizing information which synchronizes play back of the personal image and master image. A recording module records the personal image and synchronizing information on a recording medium.

### CROSS-REFERENCE TO RELATED APPLICATIONS

This application is based upon and claims the benefit of priority from Japanese Patent Application No. 2009-006803, filed Jan. 15, 2009, the entire contents of which are incorporated herein by reference.

### BACKGROUND

1. Field

One embodiment of the invention relates to a recording/play back apparatus, a play back control apparatus and method, and a recording/play back program, which are applicable to a digital television set with a hard disc drive (HDD) having a function of recording and play back video content.

2. Description of the Related Art

A method of editing and combining images recorded at different time and places is well known in imaging technology. A method of imaging the same subject at several angles by using two or more cameras is also well known (e.g., Jpn. Pat. Appln. KOKAI Publication No. 2005-26727).

In the above patent application, image data recorded by a common view supply apparatus is sent to a local imaging apparatus. In a local imaging apparatus, a user records images, and the recorded image data is recorded on a recording medium. At this time, common image data sent from a common supply apparatus can also be recorded in a local imaging apparatus at the same time. Common image data and local image data can be selectively or collectively reproduced in a local imaging apparatus.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a block diagram of an apparatus according to an embodiment of the invention;

FIG. 2 is a flowchart of an operation of an apparatus according to the invention, showing a process of recording a personal image;

FIG. 3 is a flowchart of an operation of an apparatus according to the invention, showing a process of play back a master image and a personal image;

FIG. 4 is a display example of a display unit in an apparatus according to the invention, showing a play back content display format selection screen;

FIG. 5 shows an example of a related content management database in an apparatus according to the invention;

FIG. 6 shows a display example in a display unit of an apparatus according to the invention, showing a display format selected in a play back content display format selection screen in an apparatus according to the invention;

FIG. 7 shows a display example of a display unit of an apparatus according to the invention, showing a display example of a play back content item;

FIG. 8 shows a display example of a display unit of an apparatus according to the invention, showing another play back content item; and

FIG. 9 shows a display example of a display unit of an apparatus according to the invention, showing still another play back content item.

### DETAILED DESCRIPTION

Various embodiments according to the invention will be described hereinafter with reference to the accompanying drawings.

The invention provides an easy-to-operate recording/play back apparatus, a play back control method and program and a television receiver which record a personal image related to a master image on a recording medium, and reproduce the personal image in synchronization with play back of the master image.

An embodiment of the invention comprises a play back module to reproduce a star image, and an imaging module to record a viewer as a personal image. A related content management module generates related information which has a relation between a personal image and a master image. A synchronous record control module creates synchronizing information to synchronize play back of a personal image and a master image. A recording module has a recorder to record the synchronizing information and personal image on a recording medium.

In this embodiment, recording is executed when a motion vector of a personal image is larger than a predetermined value.

In the above embodiment, when a personal image is reproduced simultaneously with a master image, the personal image and master image are identified based on the related information table, and reproduced based on the synchronizing information.

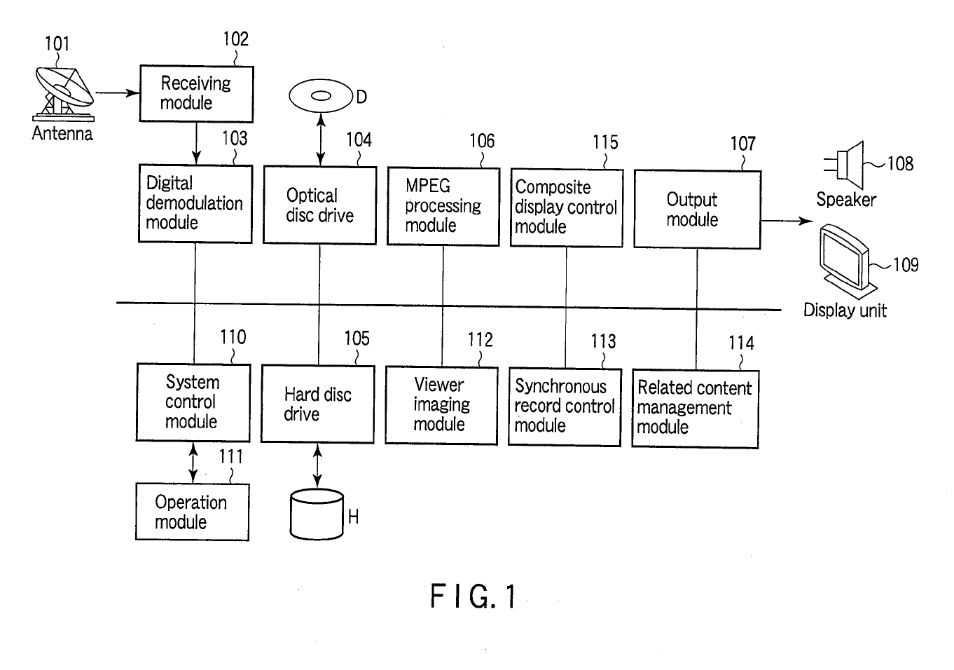

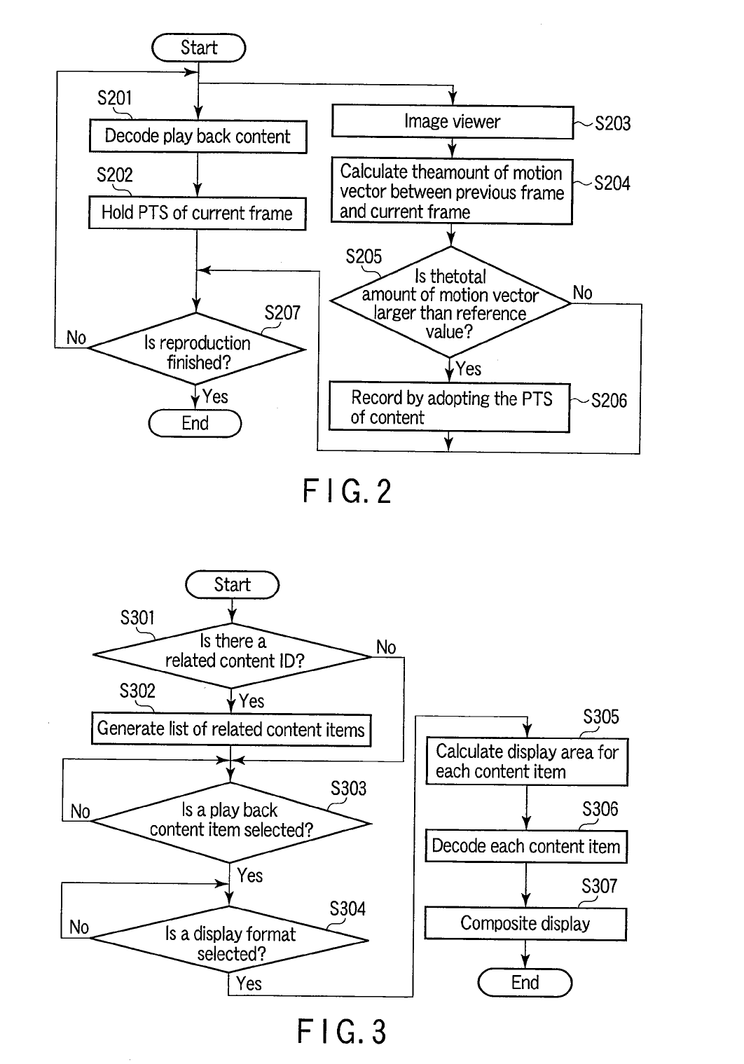

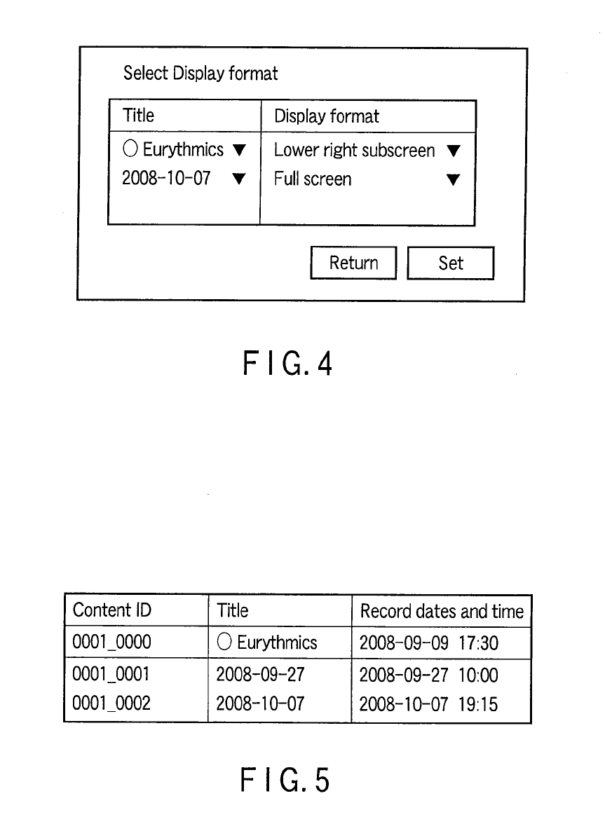

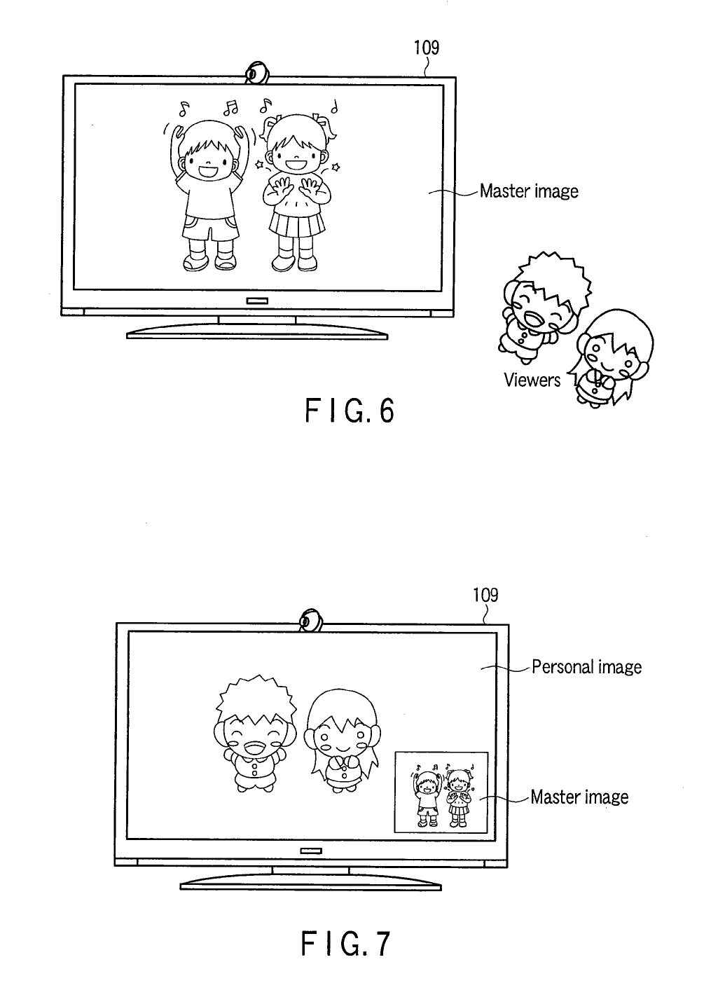

A configuration of a recording/play back apparatus according to the invention will be explained in FIG. 1. Operation examples will be explained in FIGS. 2 and 3. A play back content display format selection screen will be explained in FIG. 4. A related content management database will be explained in FIG. 5. Display examples of play back content items will be explained in FIGS. 6 to 9.

FIG. 1 shows an embodiment of a recording/play back apparatus according to the invention. A television broadcast signal is received by a receiving module 102 through an antenna 101, and is once converted to an intermediate frequency (IF) signal. A digital demodulation module 103 extracts a digital signal (a transport stream (TS) signal) from the IF signal. The TS signal is applied to an MPEG processing module 106. The MPEG processing module 106 separates the TS signal to image, sound and service information (SI) for EPG display, and decodes the image and sound.

The decoded video and audio data are output from an output module 107 to a display 109 and a speaker 108.

A system control module 110 is a processing module for controlling operations of each of modules. The system control module 110 receives control commands from an external operation module 111 such as a remote controller. The control commands include commands for recording television broadcast signals, and play back recorded content items. When a command for recording a television broadcast signal is issued, the content of a received broadcast signal is encoded by the MPEG processing module 106, and recorded on an optical disc D through an optical disc drive 104, or on a hard disc H through a hard disc drive 105.

When a command for play back the content recorded on an optical disc D or hard disc H, the content is read from the optical disc D or hard disc H. The read content is decoded by the MPEG processing module 106, and supplied to the output module 107.

The image viewing apparatus has the above-described configuration and functions. In contrast, the apparatus according to the invention further comprises a viewer imaging module 112, a synchronous record control module 113, a related content management module 114, and a composite display control module 115.

The system control module 110 is connected to the digital demodulation module 103, optical disc drive 104, hard disc drive 105, MPEG processing module 106, output module 107, viewer imaging module 112, synchronous record control module 113, and related content management module 114, through a digital signal bus.

The viewer imaging module 112 is a processing module for imaging a viewer who is viewing a master image, and has a camera. The viewer imaging module 112 may be called an imaging module. The synchronous record control module 113 is a control module for recording the viewer image recorded by the viewer imaging module 112 in synchronization with a master image. The synchronous record control module 113 holds a play back time presentation time stamp (PTS) of a master image, and is used as a synchronizing signal when recording a viewer image (may be called a personal image). At this time, the content management module 114 manages information such as content ID for relating a viewer image (a personal image) to a master image.

FIG. 5 shows an example of a database of the content management module 114. The database includes at least content ID, titles, and record dates and time. An ID is assigned to the content item to confirm the relationship between content items. For example, a content ID “0001_{—}0000” is assigned to a title “00 eurythmics” that is a master image. Further, “0001_{—}0001”, “0001_{—}0002”, . . . are assigned as personal image IDS of the content related to this master image. The personal image IDS “0001_{—}0001”, “0001_{—}0002”, . . . are recorded at different dates and time. In the drawing, only the master image “00 eurythmics” is shown, but, a similar related content management database is created for another master image.

When the viewer image and master image area simultaneously reproduced, the content management module 114 searches related content, and the composite display control module 115 determines display areas for two or more content items as play back objects, and the output module 107 controls for displaying a composite image data.

In the above configuration, it is possible to record and reproduce a master image related to two or more images of viewers watching the master image.

An explanation will be given of a flow of recording a viewer image according to the invention by using FIG. 2. In step S201, the MPEG processing module 106 decodes a master image to be reproduced. In the next step S202, the synchronous record control module 113 holds a PTS value held by a frame a master image being displayed.

In step S203 after startup, simultaneously with steps S201 and S202, the viewer imaging module 112 records viewers watching a master image. FIG. 6 shows an example of image displayed on the display 109. The drawing shows the viewers' self-learning manner while watching the image displayed on the display 109. The viewers' motion is recorded by the imaging apparatus.

Next, in steps S204 and S205, only the scene having large motion among the recorded viewers images is made recordable by analyzing the motion. Namely, the amount of motion vector between a previous frame and a current frame is calculated. When the total motion vector (the total amount in a frame) is larger than a reference value, a personal image is recorded by using a PTS of a master image as synchronizing information of a personal image. Steps S204 and S205 are not necessarily executed. When play back of a master image is finished, or when a viewer issues a play back stop instruction, recording of the personal image is finished. When play back is continued, steps S201 to S206 are repeated.

The apparatus has three channels of play back module. In a first channel, the content recorded on the optical disc D is read by the optical disc drive 104, and decoded by the MPEG processing module 106. The decoded content is output through the composite display control module 115 and output module 107. In a second channel, the content recorded on the hard disc H is read by the hard disc drive 105, and decoded by the MPEG processing module 106. The decoded content is output through the composite display control module 115 and output module 107. In a third channel, the broadcast content received by the receiving module 102 is demodulated by the digital demodulation module 103, and decoded by the MPEG processing module 106. The decoded content is output through the composite display control module 115 and output module 107.

As a recording module, there are following four channels and their combinations. In a first channel, received broadcast content is demodulated by the digital demodulation module 103, encoded by the MPEG processing module 106. The encoded content is recorded on the optical disc D through the optical disc drive 104. In a second channel, encoded content is recorded on the hard disc H through the hard disc drive 105. In the other channels, content recorded by the viewer imaging module 112 is encoded by the MPEG processing module 106, and the encoded content is recorded on the optical disc D through the optical disc drive 104. Encoded content is recorded on the hard disc H through the hard disc drive 105.

FIG. 3 shows a flowchart of simultaneous play back of a master image and a viewer image (a personal image) in the apparatus according to the invention. Steps S302 to S304 explained hereinafter are necessary for a viewer to select related content as an object of simultaneous play back, but are not necessarily executed.

First, in step S301, the related content management module 114 determines whether a related content ID exists. When a related content ID exists, a related content list is created in step S302. For example, when two or more related content IDS are detected in step S302, a list of related content is created.

In step S303, the created list is displayed, and a viewer is prompted to select object content. When a medium on which a master image is recorded actually exists as an external medium such as an optical disc, a message “insert a medium”, for example, necessary for play back of the content may be issued. Therefor, content recorded media (HDD, DVD, etc,) information may be added to the database (FIG. 5) held by the related content management module 114.

In step S304, the screen shown in FIG. 4 is displayed for the play back content selected in step S303 to prompt a viewer to select a display format. In the example of FIG. 4, a master image of identification information “00 eurythmics” and a viewer image (a personal image) expressed by identification information “2008-10-07” are selected as play back content, and set to be displayed in a lower right subscreen and full screen, respectively, as shown in FIG. 7. In the screen of FIG. 4, a title can be changed by operating a remote controller, and moving a cursor onto a desired title by touching a cursor button. It is also possible to change a personal image ID. A display format can also be changed by operating a remote controller, and moving a cursor to a desired format. A desired format can be selected by touching a next-choice button.

In step S305, a display area for each content is calculated by the composite display control module 115, based on the setting made in step S304. If steps S302 to S304 are omitted, all related content items are regarded as play back objects. In this case, a display format may be previously determined by the composite display control module 115, for example by deciding a display area by equally dividing a full screen by the number of content items.

In step S306, each play back content is decoded. In step S307, the display area calculated in step S305 is sent to the output module 107, and two or more content items are displayed in a combined mode.

Next, an explanation will be given of examples of scenes in the apparatus according to the invention by using FIGS. 6 to 9. FIG. 6 shows an example of viewing a master image, showing that children are viewing the content “00 eurythmics”. At this time, the manner of children viewing the “00 eurythmics” is recorded as a viewer image.

FIGS. 7, 8 and 9 show examples of simultaneous play back of a master image and a viewer image (a personal image). FIG. 7 shows an example, in which a viewer image (a personal image) is displayed in full screen, and a master image is displayed in a lower right subscreen.

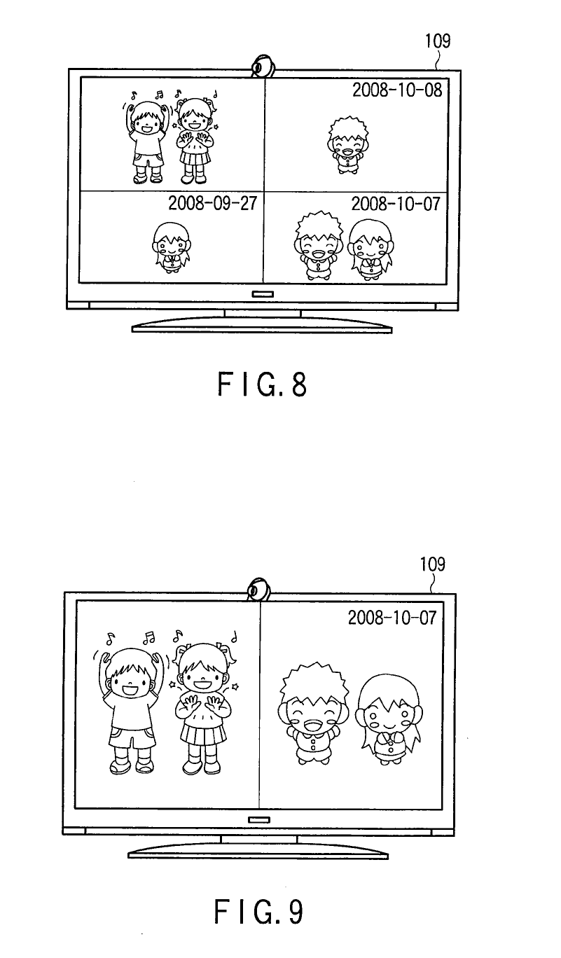

FIG. 8 shows an example, in which personal images recorded at different dates are displayed for a master image in a split-screen mode. When two or more viewer images exist, all content items may be simultaneously displayed in a split-screen mode. Further, as shown in FIG. 9, a master image may be displayed on the left side, a personal image may be displayed on the right side, and a personal image may be changeable in chronological order of record dates like a motion picture album.

As described in the flowchart of FIG. 2, a motion analysis module may be added, and only a scene of a viewer image in which a motion vector of a viewer image is large may be recorded. In this configuration, only a scene really wanted to record can be automatically extracted, and the amount of using a recording medium can be decreased. All images may be recorded to meet demand for recording all viewers watching a master image. Only the scene having a motion vector larger than a predetermined value may be reproduced as a motion picture.

Further, a viewer image may not be recorded, and a viewer image may be displayed in real time when a master image is reproduced. Recently, education service using internet has been increased. Therefore, the invention may be applied to viewing of program images supplied through network.

Accompanying with the recent health trend or diets boom, home fitness using exercise DVD and internet have received attention. Many kinds of training DVD for dance and ballet are put on the market. Eurythmics DVD for infants, and various types of video content of moving-while-viewing type for a wide age range are increased.

In viewing the above-mentioned types of content, viewers are likely to want to check their own motion. In the past, a large mirror is used, or a video camera is used to record a whole body for later checking. However, such methods are difficult to view both master and personal images at the same time. Some persons wish to record manners of their children viewing content such as eurythmics. However, children are excessively aware of a camera. It is impossible to view both master and personal images at the same time.

The invention provides an image viewing apparatus, which can relate a master image to a viewer image, and record and reproduce both images in a synchronous mode. By using a recording/play back apparatus such as a television, new applications, such as self-training and growth records of children, can be realized in addition to enlarge usage of entertainments, for example realizing a motion picture album.

While certain embodiments of the invention have been described, these embodiments have been presented by way of example only, and are not intended to limit the scope of the invention. Indeed, the novel methods and systems described herein may be embodied in a variety of other forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A recording/play back apparatus comprising:
a play back module configured to reproduce a master image;
an imaging module configured to image a viewer and obtain a personal image;
a related content management module configured to create related information which has a relation between the personal image and the master image;
a synchronizing control module configured to create synchronizing information to synchronize play back of the personal image and master image; and
a recording module configured to record the personal image and synchronizing information on a recording medium.

2. The recording/play back apparatus of claim 1, wherein the recording module executes recording when a motion vector of the personal image is larger than a predetermined value.

3. The recording/play back apparatus of claim 1, wherein the related information table manages personal images recorded at different dates and time.

4. The recording/play back apparatus of claim 1, wherein the play back module receives a master image from a receiving module when play back the master image.

5. The recording/play back apparatus of claim 1, wherein the play back module reads a master image from a recording medium when play back the master image.

6. The recording/play back apparatus of claim 1, wherein the play back module, related content management module, synchronizing control unit, and recording module are parts of a television set.

7. A play back control apparatus comprising:
an imaging module configured to image a viewer and obtain a personal image when a master image is reproduced by a play back module;
a related content management module configured to create a related information which has relation between the personal image and the master image;
a synchronizing control module configured to create synchronizing information to synchronize play back of the personal image and master image;
a recording module configured to record the personal image and synchronizing information on a recording medium; and
a control module configured to control the play back module and related content management module according to a predetermined procedure,
wherein the play back module reproduces the master image, reproduces the personal image related to the master image by the related information, in synchronization with the master image based on the synchronizing information, and outputs the master image and personal image to a display unit in a split-screen mode, or a master and subscreen mode.

8. The play back control apparatus of claim 7, wherein the play back module reproduces a part of the personal image having a motion vector larger than a predetermined value, when the personal image is reproduced.

9. The play back control apparatus of claim 7, wherein the play back module, synchronous record control module, recording module, and control module are parts of a television set.

10. A play back control method, in which a control unit controls a master image recorded on a recording medium, a personal image which is an image of a viewer watching the master image, and is recorded on the recording medium with additive synchronizing information synchronizing with the master image, and related information which has a relation between the personal image and the master image, according to a procedure controlled by a control module, comprising:
playing back the master image, and play back the personal image related to the master image by the related information, in synchronization with the master image based on the synchronizing information; and
outputting the master image and personal image to a display unit in a split-screen mode, or a master and subscreen mode.

11. The play back control method of claim 10, wherein a motion vector of the personal image is larger than a predetermined value.

12. A recording/play back program in a control module which controls a play back module, an imaging module, a related content management module, a synchronous record control module, and a recording module, comprising:
recording a viewer by the imaging module as a personal image, when the play back module reproduces a master image;
creating related information which has a relation between the personal image and the master image, in the related content management module;
creating synchronizing information to synchronize the master image with the personal image, in the synchronous record control module;
recording the personal image and synchronizing image on a recording medium, in the recording module; and
instructing the play back module to reproduce the master image, reproduce the personal image related to the master image by the related information, in synchronization with the master image based on the synchronizing information, and output the master image and personal image to a display unit in a split-screen mode, or a master and subscreen mode.
